(19) United States
(12) Patent Application Publication
(10) Pub. No.: US 2012/0087849 A1
(43) Pub. Date: Apr. 12, 2012

(54) METHOD FOR RECOVERING LANTHANUM FROM ZEOLITES CONTAINING LANTHANUM

(75) Inventor: Alexander Kehrmann, Xanten (DE)

(73) Assignee: FERRO DUO GMBH, Duisburg (DE)

(21) Appl. No.: 13/253,666

(22) Filed: Oct. 5, 2011

(30) Foreign Application Priority Data
Oct. 6, 2010 (EP) 10186669.7

(51) Int. Cl. C01F 17/00

(52) U.S. Cl. 423/21.5; 423/21.1

(57) ABSTRACT

The present invention relates to a method for recovering lanthanum from zeolite compounds containing lanthanum which is characterized in that (A) an aqueous acid is added to one or more zeolite compounds containing lanthanum so that there is a pH value of lower than or equal to 3, and (B) dissolved lanthanum is separated out. The method according to the invention makes it possible when recovering lanthanum from zeolites containing lanthanum to dispense with the use of corrosive gases such as chlorine and hydrogen chloride and with corrosive oxidative molten metals, and thus simplifies the apparatus requirements and the process. The present invention makes it possible to recover lanthanum from zeolite compounds containing lanthanum which occur as catalyst waste from large-scale chemical material conversion processes, such as, for example, the Fluid Catalytic Cracking method (FCC method), the hydrocracking method or the Claus process.

### CROSS REFERENCE TO RELATED APPLICATION

This application claims the benefit of priority under 35 U.S.C. §119(b) to EP Application Serial No. 10186669.7, filed Oct. 6, 2010, the disclosure of which is hereby incorporated herein by reference in its entirety.

### FIELD OF THE INVENTION

The present invention relates to a method for recovering lanthanum from zeolites containing lanthanum by means of conversion with aqueous mineral acids and subsequent separation of the dissolved lanthanum.

### BACKGROUND OF THE INVENTION

Sustainably ensuring the supply of raw materials is a challenge for the future, the significance of which is comparable to climate protection. Of particular interest here are metals with industrial applications such as, for example, the rare earth metals which include the elements scandium, yttrium, lanthanum of Group 3 and the 14 elements of the lanthanides following lanthanum: cerium, praseodymium, neodymium, promethium, samarium, europium, gadolinium, terbium, dysprosium, holmium, erbium, thulium, ytterbium and lutetium. The minerals of the rare earth metals are split into three large groups: (1) the cerite earths, which predominantly contain ores of the lighter lanthanides of lanthanum up to gadolinium; (2) the ytter earths which, in addition to yttrium and scandium predominantly contain ores of the heavier lanthanides from terbium to lutetium; and (3) the “complex ores” which consist to approximately the same degrees of cerite earths and ytter earths. Since the lanthanides have similar chemical and physical properties, they are relatively difficult to separate from one another. The most important ore for the production of lanthanum is monazite sand which is one of the cerite earths. Lanthanum is present in the crust of the earth at an average relative frequency of 17 ppm, and this corresponds to 17 mg of lanthanum per kg of earth crust rock.

Lanthanum has many applications in industry. Elementary lanthanum is thus used, for example, as an alloying aid in steel production for the reductive elimination of non-metallic impurities such as, for example, oxygen and sulfur. As a cast iron additive it assists the formation of nodular graphite, and as an alloy additive it brings about improvement of the oxidation stability. Lanthanum alloys have a plurality of interesting physical and chemical properties. The cobalt/lanthanum alloy (LaCo₅) is thus used, for example, as a magnetic material with permanently magnetic properties, and lanthanum nickel (LaNi₅) is used as a hydrogen store in nickel metal hydride accumulators. In association with cobalt, iron, manganese, strontium, inter alia lanthanum is used as a cathode material for high-temperature fuel cells. Lanthanum/titanium alloys are used in the medical domain for the production of corrosion-resistant and easily sterilisable instruments.

The most important oxidic lanthanum compound is lanthanum oxide (La₂O₃) which is used for the production of highly refractive glasses for producing optical lenses. La₂O₃ is used for the production of crystal glass and porcelain glazing and replaces more noxious lead compounds while at the same time improving the chemical resistance. Moreover, La₂O₃ is used in the production of ceramic capacitor materials, silicate-free glasses and glass polishing means. Further lanthanum compounds such as lanthanum boride (LaB₆) are used as cathode material for the generation of free electrons and lanthanum compounds, which are endowed with further rare earth metals, such as for example europium oxide or samarium oxide, fluoresce with a red color when stimulated with electron beams.

A plurality of lanthanum compounds have catalytic properties and are used as catalysts for cracking long-chain hydrocarbons in fuel production. Great significance is given here to the zeolites containing lanthanum which are used as heterogeneous bi-functional acid catalysts in the crude oil processing industry for the “Fluid Catalytic Cracking” process (FCC). The FCC process is the most significant material conversion process in the crude oil processing industry and enables the conversion of heavy crude oil fractions into valuable short-chain olefins such as for example ethene, propene and butene, and into cat cracker fuel, gas oil and heavy oil components. During the crack reaction large quantities of coke are produced which are deposited on the catalyst surface and quickly deactivate the latter. In order to regenerate the catalyst the coke deposits are oxidized at a temperature of 700° C. in the presence of air to form carbon monoxide or carbon dioxide. However, over the course of time the zeolite catalysts containing lanthanum that are used lose catalytic activity due to sintering and surface reduction, and must be replaced by fresh catalysts. The quantity of circulating catalyst in an FCC facility can be five times the mass of the inflow of high-boiling crude oil fractions. Since the FCC process is a large-scale chemical process, large quantities of zeolites containing lanthanum are used which, after reaching their standing time in an FCC facility are available as the basic material for the recovery of lanthanum.

In order to recover metals from catalysts, a plurality of different methods are described.

From EP 0 017 285 A1 a method is known for extracting molybdenum, vanadium and aluminum from used catalysts by treating with a mixture of elementary chlorine, hydrogen chloride and water vapor.

EP 2 157 198 A1 describes a method for extracting metallic ruthenium or ruthenium compounds from solids containing ruthenium by treating with hydrogen halide and carbon monoxide in the gas phase at temperatures of up to 700° C. The ruthenium compounds are obtained by separation in a separation zone which is colder than the reaction zone.

DE 10 2007 020 142 A2 also describes a method for recovering ruthenium in the form of ruthenium halogenide from borne catalyst materials containing ruthenium which includes fusing the catalyst material in the presence of an oxidation agent and optionally an alkali hydroxide and/or an alkali carbonate at a temperature of up to 750° C. Next the molten mass is cooled and treated with mineral acid, non-dissolved carrier material is removed, and the crude ruthenium solution is set to a maximum pH value of 5.

WO 2007/099119 A1 describes a method for the acid digestion of compounds containing metal by means of leaching using an aqueous leaching agent, the aqueous leaching agent i) containing one or more alkane sulfonic acids and optionally sulfuric acid and/or ii) a mixture of one or more alkane sulfonic acid salts and sulfuric acid. The method described in WO 2007/099119 A1 can be used to extract metals from ores containing metal such as oxides, sulfides, arsenides, halogenides, carbonates, phosphates and sulfates. The treatment of copper ore with sulfuric acid and/or methane sulfonic acid or sodium methane sulfonate for 26.5 hours (2.5 hours intensive stirring and left standing for 24 hours) leads, for example, to copper yields of between 35 and 38% in the filtrate.

In the current prior art, as yet no method has been described for the recovery of lanthanum from zeolite compounds containing lanthanum and which have been used as catalysts in an FCC facility.

Disadvantages of the methods described above for the recovery of metals from carrier catalysts are on the one hand the high temperatures required and the high energy use caused by this, as well as the use of corrosive gases such as chlorine and hydrogen chloride or the production of a corrosive oxidative molten metallic salt which has significant apparatus requirements for large-scale conversion.

On the other hand, with the methods described above for the recovery of metals from carrier catalysts, repeated treatments with the respective agents are required in order to achieve the most complete recovery possible of the metals from the respective catalyst carrier materials. This is in particular the case if the metal type provided for the recovery is connected securely to the carrier material. Such repeated treatment leads to the time required and the energy used for the metal recovery being further increased.

### SUMMARY OF THE INVENTION

It is therefore an object of the invention to make available an appropriate method which enables the recovery of lanthanum from zeolite compounds containing lanthanum. The zeolite compounds containing lanthanum for the method according to the invention are in particular catalyst waste from large-scale chemical material conversion processes such as for example the FCC process, the hydrocracking process or the Claus process.

It is the object of the invention to achieve the object expressed above. In particular, the object expressed above is achieved by

[1] a method for recovering lanthanum from zeolites containing lanthanum, characterized in that (A) an aqueous acid is added to one or more zeolite compounds containing lanthanum so that there is a pH value of lower than or equal to 3, and (B) dissolved lanthanum is separated out;

[2] a method for recovering lanthanum from zeolites containing lanthanum according to item [1], characterized in that the zeolite compounds containing lanthanum have a grain size of less than or equal to 200 μm;

[3] a method for recovering lanthanum from zeolites containing lanthanum according to item [1], characterized in that the zeolite compounds containing lanthanum have a grain size of less than or equal to 10 μm;

[4] a method for recovering lanthanum from zeolites containing lanthanum according to items [1], [2] or [3], characterized in that the zeolite compounds containing lanthanum are present in a mixture with further compounds that do not contain lanthanum;

[5] a method for recovering lanthanum from zeolites containing lanthanum according to items [1], [2], [3] or [4], characterized in that the zeolite compounds containing lanthanum have a faujasite and/or zeolite Y structure;

[6] a method for recovering lanthanum from zeolites containing lanthanum according to item [5], characterized in that the zeolite compounds containing lanthanum contain aluminum in a substance amount percentage of 37.5 to 47.5 mole % Al₂O₃ and silicon in a substance amount percentage of 42.5 to 52.5 mole % SiO₂, for every zeolite compound containing lanthanum the sum of the substance amount percentages for all of the compounds present being 100 mole %;

[7] a method for recovering lanthanum from zeolites containing lanthanum according to item [6], characterized in that the zeolite compounds containing lanthanum contain lanthanum in a substance amount percentage of 0.5 to 5 mole % La₂O₃;

[8] a method for recovering lanthanum from zeolites containing lanthanum according to items [1], [2], [3], [4], [5], [6] or [7], characterized in that the pH value is lower than or equal to 2;

[9] a method for recovering lanthanum from zeolites containing lanthanum according to items [1], [2], [3], [4], [5], [6] or [7], characterized in that the pH value is lower than or equal to 1;

[10] a method for recovering lanthanum from zeolites containing lanthanum according to items [1], [2], [3], [4], [5], [6] or [7], characterized in that the pH value is lower than or equal to 0;

[11] a method for recovering lanthanum from zeolites containing lanthanum according to items [1], [2], [3], [4], [5], [6], [7], [8], [9] or [10], characterized in that the aqueous acid is aqueous hydrochloric acid, aqueous sulfuric acid or aqueous nitric acid, or a mixture of at least two of these acids;

[12] a method for recovering lanthanum from zeolites containing lanthanum according to items [1], [2], [3], [4], [5], [6], [7], [8], [9], [10] or [11], characterized in that (B) dissolved lanthanum is separated by filtration from insoluble solid residue;

[13] a method for recovering lanthanum from zeolites containing lanthanum according to item [12], characterized in that lanthanum dissolved in the filtrate is separated out by selective crystallization, selective precipitation or selective ion exchange of aluminum dissolved in the filtrate;

[14] a method for recovering lanthanum from zeolites containing lanthanum according to item [12], characterized in that lanthanum dissolved in the filtrate is separated out by selective crystallization of aluminum dissolved in the filtrate;

[15] a method for recovering lanthanum from zeolites containing lanthanum according to item [12], characterized in that lanthanum dissolved in the filtrate is separated out by selective precipitation of aluminum dissolved in the filtrate;

[16] a method for recovering lanthanum from zeolites containing lanthanum according to item [12], characterized in that lanthanum dissolved in the filtrate is separated out by selective ion exchange of aluminum dissolved in the filtrate;

[17] a method for recovering lanthanum from zeolites containing lanthanum according to items [1], [2], [3], [4], [5], [6], [7], [8], [9], [10], [11], [12], [13], [14], [15] or [16], characterized in that (A) an aqueous acid is added to one or more zeolite compounds containing lanthanum, and during the acid digestion no heat is introduced from the outside.

### BRIEF DESCRIPTION OF THE DRAWINGS

FIG. 1 shows a flow chart that describes a possible embodiment of the method according to the invention. Here the zeolite compounds containing lanthanum are treated with water and an aqueous acid so that acid digestion takes place. The acid digestion can optionally take place while stirring and/or introducing heat. Next the insoluble solid residue is separated out, for example by means of filtration, washed and pressed out in order to obtain a filter cake which is optionally made available once again for acid decomposition or is disposed of as solid waste. The dissolved lanthanum salts contained in the filtrate are separated out of the solution by precipitation, crystallization, ion exchange etc.

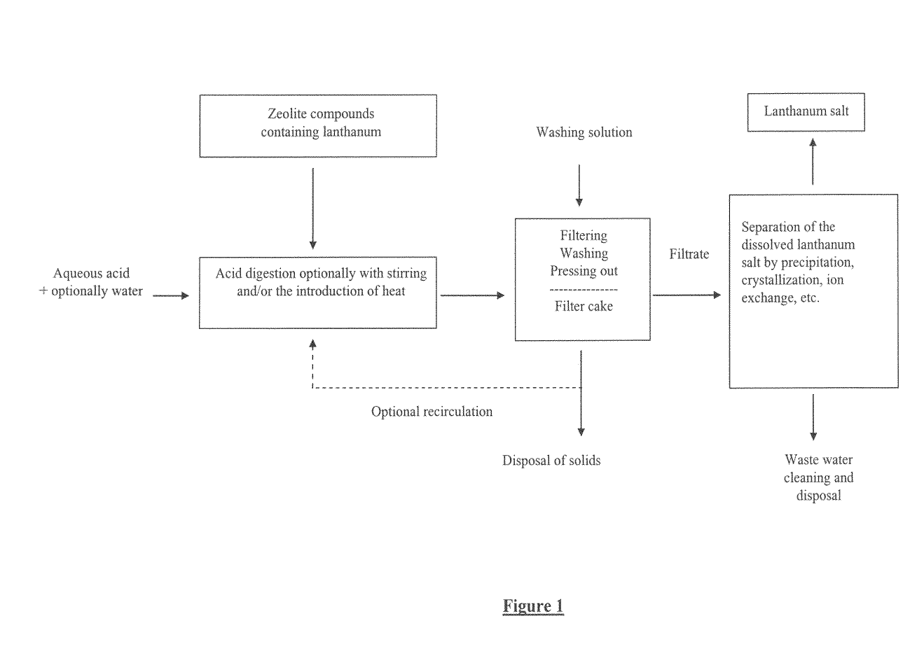

### DESCRIPTION OF THE ILLUSTRATIVE EMBODIMENTS

Definitions:

The term “zeolites containing lanthanum” designates all zeolites which have been modified by ion exchange or some other chemical treatment such that they contain one or more lanthanum atoms (atomic number 57) which as lanthanum ions can optionally be positively charged.

The term “recovery of lanthanum” relates to the separation of lanthanum from zeolites containing lanthanum with the aid of chemical and/or physical procedural steps. The recovery of lanthanum from zeolites containing lanthanum includes the precipitation of lanthanum atoms and/or lanthanum ions with the aid of an aqueous solvent, and optionally includes a subsequent single- or multiple-step filtration process for the solution containing lanthanum which makes it possible to separate out the dissolved lanthanum in the form of a lanthanum salt.

Zeolite Compounds Containing Lanthanum:

Zeolite compounds containing lanthanum are all compounds from the zeolite group which have been modified by ion exchange or some other chemical treatment such that they contain one or more lanthanum atoms which, as lanthanum ions, can optionally be positively charged. Here, on the one hand there may exist one or more lanthanum atoms per one structural unit of the zeolite, or on the other hand one lanthanum atom per more than one structural unit of the zeolite as is the case, for example, with a lanthanum doping.

Zeolite compounds are crystalline alumosilicates which occur in numerous modifications in nature, but can also be produced synthetically. The general composition of zeolite compounds is given by the following formula: M_{x/n}[(AlO₂)ₓ(SiO₂)_{y}].z H₂O, M being a metal, n specifying the charge of the metal, and mostly n=1 or 2, and x, y and z being positive integers. Important zeolite compounds are, inter alia, ZSM-5, zeolite A and zeolite Y. Zeolite compounds consist of AlO₄ and SiO₄ tetrahedra which form a microporous framework structure which can have a very large inner surface of partially more than 1000 m² per g. By means of trivalent aluminum atoms to which two bivalent oxygen particles can be formally assigned, zeolites have an anionic framework charge. On the inner and outer surfaces of zeolites containing aluminum there are cations, such as for example Na⁺, K⁺, Ca²⁺ and Mg²⁺ which are interchangeable. Zeolite compounds can be modified by ion exchange or some other chemical treatment so that they contain one or more lanthanum atoms which as lanthanum ions can be positively charged. Zeolite compounds containing lanthanum, which are obtained starting from zeolite Y, have a faujasite structure or a zeolite Y structure, and are preferably used as the basic material for the method according to the invention.

The zeolite compounds containing lanthanum which are used as the basic material for the method according to the invention preferably have a faujasite and/or zeolite Y structure.

The zeolite compounds containing lanthanum which are used as the basic material for the method according to the invention contain aluminum, silicon, oxygen and lanthanum. Optionally, further metal atoms, which as metal ions can optionally be positively charged, or further non-metal atoms, which as non-metal ions can optionally be negatively charged, can be contained in the zeolite compounds containing lanthanum.

Further metal atoms are, for example, lithium, sodium, potassium, magnesium, calcium, iron and titanium, preferably sodium, iron and titanium. Further non-metal atoms are, for example, hydrogen, boron, carbon, nitrogen, sulfur, fluorine, chlorine and bromine.

The chemical composition of the zeolite compounds containing lanthanum can be determined with the aid of energy-dispersive X-ray spectroscopy (EDX). Furthermore, X-ray diffraction analyses can be used to characterize the zeolite compounds containing lanthanum.

The zeolite compounds containing lanthanum which are used as the basic material for the method according to the invention preferably have a faujasite and/or zeolite Y structure and preferably contain aluminum in a substance amount percentage of 37.5 to 47.5 mole % Al₂O₃ and silicon in a substance amount percentage of 42.5 to 52.5 mole % SiO₂, more preferably aluminum in a substance amount percentage of 38.5 to 46.5 mole % Al₂O₃ and silicon in a substance amount percentage of 43.5 to 51.5 mole %, even more preferably aluminum in a substance amount percentage of 39.5 to 45.5 mole % Al₂O₃ and silicon in a substance amount percentage of 44.5 to 50.5 mole % SiO₂, and even more preferably aluminum in a substance amount percentage of 40.5 to 44.5 mole % Al₂O₃ and silicon in a substance amount percentage of 45.5 to 49.5 mole % SiO₂ and most preferably aluminum in a substance amount percentage of 41.5 to 43.5 mole % Al₂O₃ and silicon in a substance amount percentage of 46.5 to 48.5 mole % SiO₂, for each zeolite compound containing lanthanum the sum of the substance amount percentages of all of the components present being 100 mole %.

The zeolite compounds containing lanthanum which are used as the basic material for the method according to the invention preferably have a faujasite and/or zeolite Y structure and preferably contain lanthanum in a substance amount percentage of 0.5 to 5 mole % La₂O₃, more preferably lanthanum in a substance amount percentage of 0.5 to 4 mole % La₂O₃, even more preferably lanthanum in a substance amount percentage of 0.5 to 3 mole % La₂O₃, even more preferably lanthanum in a substance amount percentage of 0.5 to 2 mole % La₂O₃, and most preferably lanthanum in a substance amount percentage of 0.9 to 2 mole % La₂O₃, for every zeolite compound containing lanthanum the sum of the substance amount percentages of all of the components present being 100 mole %.

In a preferred embodiment the zeolite compounds containing lanthanum which are used as the basic material for the method according to the invention have a faujasite and/or zeolite Y structure and contain aluminum in a substance amount percentage of 37.5 to 47.5 mole % Al₂O₃, silicon in a substance amount percentage of 42.5 to 52.5 mole % SiO₂, and lanthanum in a substance amount percentage of 0.5 to 5 mole % La₂O₃, for each zeolite compound containing lanthanum the sum of the substance amount percentages of all of the components present being 100 mole %.

In a further preferred embodiment the zeolite compounds containing lanthanum which are used as the basic material for the method according to the invention have a faujasite and/or zeolite Y structure and contain aluminum in a substance amount percentage of 38.5 to 46.5 mole % Al₂O₃, silicon in a substance amount percentage of 43.5 to 51.5 mole % SiO₂, and lanthnum in a substance amount percentage of 0.5 to 4 mole % La₂O₃, for every zeolite compound containing lanthanum the sum of the substance amount percentages of all of the components present being 100 mole %.

In a further preferred embodiment the zeolite compounds containing lanthanum which are used as the basic material for the method according to the invention have a faujasite and/or zeolite Y structure and contain aluminum in a substance amount percentage of 39.5 to 45.5 mole % Al₂O₃, silicon in a substance amount percentage of 44.5 to 50.5 mole % SiO₂ and lanthanum in a substance amount percentage of 0.5 to 3 mole % La₂O₃, for every zeolite compound containing lanthanum the sum of the substance amount percentages of all of the components present being 100 mole %.

In a further preferred embodiment the zeolite compounds containing lanthanum which are used as the basic material for the method according to the invention have a faujasite and/or zeolite Y structure and contain aluminum in a substance amount percentage of 40.5 to 44.5 mole % Al₂O₃, silicon in a substance amount percentage of 45.5 to 49.5 mole % SiO₂, and lanthanum in a substance amount percentage of 0.5 to 2 mole % La₂O₃, for every zeolite compound containing lanthanum the sum of the substance amount percentages of all of the components present being 100 mole %.

In a further preferred embodiment the zeolite compounds containing lanthanum which are used as the basic material for the method according to the invention have a faujasite and/or zeolite Y structure and contain aluminum in a substance amount percentage of 41.5 to 43.5 mole % Al₂O₃, silicon in a substance amount percentage of 46.5 to 48.5 mole % SiO₂, and lanthanum in a substance amount percentage of 0.9 to 2 mole % La₂O₃, for every zeolite compound containing lanthanum the sum of the substance amount percentages of all of the components present being 100 mole %.

The zeolite compounds containing lanthanum are used as the basic material for the method according to the invention and can be present in a mixture with further compounds not containing lanthanum without this having any disadvantageous effect upon the recovery of the lanthanum from the zeolite compounds containing lanthanum. Compounds not containing lanthanum are preferably zeolite compounds not containing lanthanum.

The zeolite compounds containing lanthanum can be zeolite catalyst waste from large-scale chemical material conversion processes, such as for example the fluid catalytic cracking process (FCC process), the hydrocracking process or the Claus process.

The zeolite compounds containing lanthanum are the basic material for the method according to the invention and have a grain size of preferably smaller than or equal to 200 μm, more preferably smaller than or equal to 100 μm, even more preferably smaller than or equal to 50 μm, even more preferably smaller than or equal to 30 μm, even more preferably smaller than or equal to 20 μm, and most preferably smaller than or equal to 10 μm. Generally, however, the grain size of the zeolite compounds containing lanthanum is not smaller than 1 μm.

In order to achieve the preferred grain sizes, the zeolite compounds containing lanthanum can optionally be broken up before their use as the basic material for the method according to the invention. The breaking up can be implemented by grinding, milling or by ultrasound. If necessary, a grading step using, for example, a sieve can follow the breaking up.

The maximum grain sizes of the zeolite compounds containing lanthanum can be determined with the aid of corresponding laser granulometric grain size distribution analysis.

Acid Digestion of the Zeolite Compounds Containing Lanthanum (A):

The method according to the invention is characterized in that an aqueous acid is added to the zeolite compounds containing lanthanum and in this way the lanthanum atoms and/or lanthanum ions present in the zeolite compounds containing lanthanum are dissolved. During this acid digestion of the zeolite compound containing lanthanum thorough mixing is implemented by an appropriate stirring device so that the lanthanum atoms and/or lanthanum ions present in the zeolite compounds containing lanthanum are dissolved.

The acid digestion of the zeolite compounds containing lanthanum can optionally be implemented by introducing heat from the outside or without the introduction of heat from the outside. In a preferred embodiment of the method according to the invention the acid digestion of the zeolite compound containing lanthanum takes place without the introduction of heat from the outside.

During the acid digestion it is essential that there is a pH value of lower than or equal to 3, preferably lower than or equal to 2, more preferably of lower than or equal to 1, and most preferably lower than or equal to 0.

If the pH value is higher than 3, only a small portion of the lanthanum present in the zeolites containing lanthanum is dissolved.

In a preferred embodiment of the method according to the invention the pH value is in the range of −1 to 3, more preferably in the range of −1 to 2, and most preferably in the range of −1 to 1.

In a further preferred embodiment of the method according to the invention the pH value is in the range of 0 to 3, more preferably in the range of 0 to 2, and most preferably in the range of 0 to 1.

In a further embodiment the pH value is in the range of 1 to 3, more preferably in the range of 1 to 2, and even more preferably in the range of 2 to 3.

In a further preferred embodiment of the method according to the invention the pH value is in a symmetrical interval of around 1, such as preferably from 0.25 to 1.75, from 0.5 to 1.5, from 0.6 to 1.4, from 0.7 to 1.3, from 0.75 to 1.25, from 0.8 to 1.2, from 0.85 to 1.15, from 0.9 to 1.1, and from 0.95 to 1.05.

In a further preferred embodiment of the method according to the invention the pH value is in a symmetrical interval of around 0, such as preferably from −0.75 to 0.75, from −0.5 to 0.5, from −0.4 to 0.4, from −0.3 to 0.3, from −0.25 to 0.25, from −0.2 to 0.2, from −0.15 to 0.15, from −0.1 to 0.1, and from −0.05 to 0.05.

The aqueous acid used for the solution of the lanthanum atoms from the zeolite compounds containing lanthanum is a mixture of water and a mineral acid and/or an organic acid.

Hydrochloric acid, sulfuric acid, nitric acid and phosphoric acid are preferably used as mineral acid.

Sulfonic acids and phosphonic acids are preferably used as organic acids. Cyclic, linear and branched alkane sulfonic acids, the alkyl residues of which have 1 to 20 carbon atoms, can be used in the present invention as sulfonic acids. Methane sulfonic acid, ethane sulfonic acid, propane sulfonic acid and sulfonic acids with linear or branched alkyl residues which have 4 to 12 carbon atoms are preferred. In the present invention cyclic, linear and branched alkane phosphonic acids, the alkyl residues of which have 1 to 20 carbon atoms, can be used as phosphonic acids. Methane phosphonic acid, ethane phosphonic acid, propane phosphonic acid and phosphonic acids with linear or branched alkyl residues which have 4 to 12 carbon atoms are preferred.

One, two, three or more of the acids specified above can be used in combination for the solution of the lanthanum atoms from the zeolite compounds containing lanthanum. In the present invention the acids are used in the form of aqueous acids which are aqueous solutions. The aqueous acids can be concentrated aqueous acids or diluted aqueous acids. Concentrated aqueous acids are saturated aqueous solutions of the corresponding acid compound. Diluted aqueous solutions are non-saturated aqueous solutions of the corresponding acid compound. If a concentrated aqueous acid is used, when adding the concentrated aqueous acid to the zeolite compound containing lanthanum dilution of the concentrated aqueous solution with water can take place. The dilution of the concentrated aqueous solution with water can take place by the concentrated aqueous acid being added to water or water being added to the concentrated aqueous acid. The dilution of the concentrated aqueous acid can take place before, during or after the addition of the concentrated aqueous acid to the zeolite compound containing lanthanum.

Preferably, in the method according to the invention aqueous hydrochloric acid, aqueous sulfuric acid or aqueous nitric acid or a mixture of at least two of these acids is used. Aqueous hydrochloric acid is more preferable. Particularly preferred is the use of diluted aqueous acids such as diluted aqueous hydrochloric acid, diluted aqueous sulfuric acid or diluted aqueous nitric acid or a mixture of at least two of these acids. Most preferable is diluted aqueous hydrochloric acid.

Separation of the Dissolved Lanthanum (B):

By displacing the zeolite compound containing lanthanum with an aqueous acid the lanthanum atoms and/or lanthanum ions present in the zeolite compounds containing lanthanum are dissolved. The lanthanum present in solution is then separated from the insoluble solid residue using an appropriate method. For this separation, separation methods known to the person skilled in the art and which enable separation upon the basis of the density or particle size are used. Separation methods which enable separation upon the basis of density are, for example, sedimentation, decantation, centrifugation, heavy medium separation and elutriation. Separation methods which enable separation upon the basis of the particle size are, for example, filtration, screening, sieving, sifting and membrane separation methods.

In one preferred embodiment of the method according to the invention the separation of the lanthanum present in solution from the insoluble solid residue is implemented by a separation method which enables separation upon the basis of the particle size. In a particularly preferred embodiment of the method according to the invention the separation of the lanthanum present in solution from the insoluble solid residue is implemented by filtration.

The solid obtained after the separation is washed and pressed out. The aqueous acid with which the acid digestion of the zeolite compound containing lanthanum was previously implemented is preferably used as the washing solution. Optionally, washing solutions of different types, such as for example aqueous washing solutions, non-aqueous washing solutions or water can also be used. The washed and pressed out solid can optionally be made available once again for acid digestion so as to dissolve any remaining non-dissolved lanthanum, or is disposed of as solid waste. The solution containing lanthanum obtained by the separation from the insoluble solid residue is made available for a further separation step (B) which makes it possible to separate out the dissolved lanthanum contained therein.

Separation step (B) makes it possible to separate the lanthanum contained in the solution from any other elements, such as for example aluminum, contained in the solution. Aluminum, which is a component of the zeolite compounds containing lanthanum, can be present in solution together with lanthanum, whereas silicon, which is also a component of the zeolite compounds containing lanthanum, is not in solution under the conditions according to the invention of the acid digestion, and so is not present in solution together with lanthanum. Separation step (B) can include any methods known to the person skilled in the art and which enable separation of lanthanum and aluminum in aqueous solution.

Appropriate methods for separating lanthanum and aluminum in aqueous solution are, for example, the selective crystallization of lanthanum or aluminum from aqueous solution; the selective precipitation of lanthanum or aluminum from aqueous solution by adding an appropriate precipitating agent which enables selective precipitation of lanthanum or aluminum from aqueous solution; and the selective ion exchange of lanthanum or aluminum from aqueous solution by using an appropriate ion exchanger which enables selective ion exchange of lanthanum or aluminum from aqueous solution. The selective crystallization of lanthanum or aluminum from aqueous solution can take place directly or after reduction of the aqueous solution by evaporation.

The preferred separation methods included in separation step (B) are the selective crystallization of lanthanum from aqueous solution, the selective precipitation of lanthanum from aqueous solution by adding an appropriate precipitation means which enables selective precipitation of lanthanum from aqueous solution, and the selective ion exchange of lanthanum from aqueous solution by using an appropriate ion exchanger which enables selective ion exchange of lanthanum from aqueous solution. All of these preferred separation methods included in separation step (B) enable the separation of the lanthanum ions contained in the aqueous solution in the form of a lanthanum salt.

If selective ion exchange of lanthanum from aqueous solution is implemented in separation step (B) by using an appropriate ion exchanger which enables selective ion exchange, the ion exchanger charged with lanthanum ions is then separated from the aqueous solution, and the lanthanum ions bound in the latter are released by an appropriate method so that the ion exchanger charged with lanthanum ions is regenerated, and the released lanthanum ions can be isolated in the form of a lanthanum salt. The regeneration of the ion exchanger charged with lanthanum ions can be implemented by washing out the lanthanum ions with an appropriate complexing agent such as, for example, a solution of ammonium citrate or ammonium nitrilotriacetate.

In a particularly preferred embodiment of the method according to the invention separation step (B) includes selective crystallization of lanthanum from aqueous solution.

In a further particularly preferred embodiment of the method according to the invention separation step (B) includes selective precipitation of lanthanum from aqueous solution by adding an appropriate precipitating agent which enables selective precipitation of lanthanum from aqueous solution.

Appropriate precipitating agents which enable selective precipitation of lanthanum from aqueous solution are, for example, water-soluble oxalic acid salts such as, for example, ammonium oxalate ((NH₄)₂C₂O₄), sodium oxalate (Na₂C₂O₄) and potassium oxalate (K₂C₂O₄).

In a further particularly preferred embodiment of the method according to the invention separation step (B) includes selective ion exchange of lanthanum from aqueous solution by using an appropriate ion exchanger which enables selective ion exchange of lanthanum from aqueous solution.

Appropriate ion exchangers which enable selective ion exchange of lanthanum from aqueous solution can be solid ion exchangers (solid/liquid extraction) or liquid ion exchangers (liquid/liquid extraction). Liquid ion exchangers are appropriate organic liquids that can not be mixed with water, such as for example tributyl phosphate, 2-ethylhexl phosphonic acid-2-ethylhexyl ester or bis-2-ethylhexyl phosphate.

Use of the Recovered Lanthanum:

The lanthanum recovered by the method according to the invention is obtained as lanthanum salt by separation step (B). Lanthanum salts which are obtained by the method according to the invention are, for example, lanthanum chloride (LaCl₃), lanthanum sulfate (La₂(SO₄)₃), lanthanum oxalate (La₂(C₂O₄)₃), lanthanum nitrate (La(NO₃)₃), lanthanum fluoride (LaF₃), lanthanum phosphate (LaPO₄), and lanthanum salts of alkane sulfonic acids and lanthanum salts of alkane phosphonic acids. The aforementioned lanthanum salts can be obtained by evaporation, crystallization, ion exchange or precipitation. Lanthanum oxalate (La₂(C₂O₄)₃) is preferably produced and separated by means of precipitation and can be converted into lanthanum oxide (La₂O₃) by burning. Lanthanum oxide (La₂O₃) can be converted into lanthanum fluoride (LaF₃) with hydrogen fluoride which can be reduced with elementary calcium to form elementary lanthanum (La).

The lanthanum salts obtained by the method according to the invention and the products obtained from the latter by chemical conversions, such as for example elementary lanthanum (La), can be used for a plurality of technical applications.

Thus, for example, lanthanum oxide, which is extracted starting with a lanthanum salt obtained according to the present invention, can be used for the production of highly refractive glasses for the production of optical lenses, for the production of crystal glass, silicate-free glasses, glass polishing agents, porcelain glazing and ceramic capacitor materials.

Thus, for example, elementary lanthanum, which is extracted starting with a lanthanum salt obtained according to the present invention, can be used for the production of alloys with metals such as chromium, manganese, iron, cobalt, nickel, iron, strontium and titanium. The lanthanum alloys obtained in this way can be used, for example, as magnetic materials, hydrogen stores, cathode materials and as materials for the production of corrosion-resistant medical instruments. Likewise, elementary lanthanum, which is extracted starting with a lanthanum salt obtained according to the present invention, can be used in steel production for the reductive elimination of non-metallic impurities and as a cast iron additive.

Moreover, further lanthanum compounds can be extracted from the lanthanum salts obtained according to the present invention, such as for example lanthanum boride (LaB₆), which can be used as cathode materials, or such as for example lanthanum compounds, which are endowed with rare earth metals, such as for example europium oxide or samarium oxide, and can be used as fluorescence materials.

Furthermore, the lanthanum salts extracted according to the present invention can be used for the production of catalysts.

Process:

The method according to the invention can be executed continuously or discontinuously (batch).

The present invention provides a method which permits the recovery of lanthanum from zeolites containing lanthanum, and which is characterized by dispensing with the use of corrosive gases such as chlorine and hydrogen chloride and of corrosive oxidative molten metals, and thus simplifies the apparatus requirements and the recovery process. In particular, the present invention provides a method which permits the recovery of lanthanum from zeolites containing lanthanum and is characterized by a high yield of recovered lanthanum after just one recovery cycle according to the method. Moreover, the present invention provides a method which makes it possible to recover lanthanum from zeolites containing lanthanum, and is characterized by reduced use of energy and time. Moreover, the present invention provides a method which makes it possible to recover lanthanum from zeolite compounds containing lanthanum which occur as catalyst waste from large-scale chemical material conversion processes such as, for example, the FCC method, the hydrocracking method or the Claus process.

### EXAMPLES

The following examples illustrate the effect of the method according to the invention:

A zeolite catalyst containing lanthanum, which had been used in an FCC method for cracking hydrocarbons, served as the basic material for the experiments described in Tab. 1.

In the reference analysis the composition of the zeolite catalyst containing lanthanum originating from the FCC method was determined by means of ICP optical emission spectrometry (ICP OES), infrared spectroscopy (IR) at 950° C. and X-ray fluorescence analysis (RFA). The contents for the types of metal specified in Tab. 1 were determined starting with the non-treated solid substance of the zeolite catalyst containing lanthanum.

For Tests 1 and 2 and Comparison Tests 1 and 2 approx. 100 mL were added to 5 g respectively of the zeolite catalyst sample containing lanthanum and boiled (see Tab. 1). For the sample with pH 0 (Test 1) an approx. 1 mole/1 hydrochloric acid was used. The sample with pH 3 (Test 2) was set up with 37% hydrochloric acid, and the sample with pH 6 (Comparison Test 1) was only boiled in water. The sample with pH 14 (Comparison Test 2) was boiled with KOH for 2 hours on the reflow. All of the samples were respectively filtered after approx. 15 mins boiling time and rinsed with water. The residue was dried at 105° C., and the filtrate was filled up to 200 ml.

The lanthanum contents in the filter residue and the filtrate were determined by means of ICP optical emission spectrometry (ICP OES). The contents of calcium oxide, magnesium oxide, sulfate as SO₃, sodium oxide and potassium oxide in the filtrate were determined by means of X-ray fluorescence analysis (RFA) (see Tab. 1).

TABLE 1

| | | | Reference | Test | Test | Comparison | Comparison |
|---|---|---|---|---|---|---|---|
| Experiment | | | analysis | 1 | 2 | Test 1 | Test 2 |
| Sample designation: | | | FCC Fluid | pH 0 | pH 3 | pH 6 | pH 14 |
| | | | Catalytic | | | | |
| | | | Cracking | | | | |
| Dry residue | | % | | 79.50 | 98.69 | 99.27 | 79.81 |
| Lanthanum in | ICP OES | % | | 1.87 | 0.15 | <0.01 | <0.01 |
| the filtrate | | | | | | | |
| Lanthanum in | ICP OES | % | 1.20 | 0.10 | 0.90 | 0.90 | 0.90 |
| the residue | | | | | | | |
| Dissolved | calculated | % | | 94.92 | 14.29 | <1 | <1 |
| lanthanum | | | | | | | |
| Carbon dioxide | 950 C./IR | % | 0.15 | | | | |
| Water | 950 C./IR | % | 2.60 | | | | |
| Silicon (IV) oxide | RFA | % | 47.54 | | | | |
| Aluminum oxide | RFA | % | 42.50 | | | | |
| Iron (III) oxide | RFA | % | 0.07 | | | | |
| Phosphorus (V) | RFA | % | 0.14 | | | | |
| oxide | | | | | | | |
| Titanium dioxide | RFA | % | 1.11 | | | | |
| Manganese (III) | RFA | % | 0.01 | | | | |
| oxide | | | | | | | |
| Calcium oxide | RFA | % | 0.11 | 0.03* | <0.01* | <0.01* | |
| Magnesium oxide | RFA | % | 0.10 | 0.01* | <0.01* | <0.01* | |
| Sulfate as SO₃ | RFA | % | 0.14 | 0.03* | <0.01* | <0.01* | |
| Sodium sulfate | RFA | % | 0.72 | 0.20* | 0.05 | 0.01* | |
| Potassium oxide | RFA | % | 0.01 | 0.02* | 0.01 | <0.01* | |

*dissolved ions in the filtrate

The results in Tab. 1 show that with a pH value of 0 (Test 1) 94.92% of the lanthanum atoms from the zeolite catalyst containing lanthanum used are dissolved, whereas with pH values of more than 3 (Comparison Tests 1 and 2) less than 0.01% of the lanthanum atoms from the zeolite catalyst containing lanthanum used are dissolved.

What is claimed is:

1. A method for recovering lanthanum from zeolites containing lanthanum, characterized in that (A) an aqueous acid is added to one or more zeolite compounds containing lanthanum so that there is a pH value of lower than or equal to 3, and (B) dissolved lanthanum is separated out.

2. The method for recovering lanthanum from zeolites containing lanthanum according to claim 1, characterized in that the zeolite compounds containing lanthanum have a grain size of less than or equal to 200 μm.

3. The method for recovering lanthanum from zeolites containing lanthanum according to claim 1, characterized in that the zeolites containing lanthanum have a grain size of less than or equal to 10 μm.

4. The method for recovering lanthanum from zeolites containing lanthanum according to claim 2, characterized in that the zeolite compounds containing lanthanum are present in a mixture with further compounds that do not contain lanthanum.

5. The method for recovering lanthanum from zeolites containing lanthanum according to claim 3, characterized in that the zeolite compounds containing lanthanum are present in a mixture with further compounds that do not contain lanthanum.

6. The method for recovering lanthanum from zeolites containing lanthanum according to claim 1, characterized in that the zeolite compounds containing lanthanum have a faujasite and/or zeolite Y structure.

7. The method for recovering lanthanum from zeolites containing lanthanum according to claim 2, characterized in that the zeolite compounds containing lanthanum have a faujasite and/or zeolite Y structure.

8. The method for recovering lanthanum from zeolites containing lanthanum according to claim 3, characterized in that the zeolite compounds containing lanthanum have a faujasite and/or zeolite Y structure.

9. The method for recovering lanthanum from zeolites containing lanthanum according to claim 4, characterized in that the zeolite compounds containing lanthanum have a faujasite and/or zeolite Y structure.

10. The method for recovering lanthanum from zeolites containing lanthanum according to claim 6, characterized in that the zeolite compounds containing lanthanum contain aluminum in a substance amount percentage of 37.5 to 47.5 mole % Al₂O₃ and silicon in a substance amount percentage of 42.5 to 52.5 mole % SiO₂, for every zeolite compound containing lanthanum the sum of substance amount percentages for all of the compounds present being 100 mole %.

11. The method for recovering lanthanum from zeolites containing lanthanum according to claim 10, characterized in that the zeolite compounds containing lanthanum contain lanthanum in a substance amount percentage of 0.5 to 5 mole % La₂O₃.

12. The method for recovering lanthanum from zeolites containing lanthanum according to claim 1, characterized in that the pH value is lower than or equal to 2.

13. The method for recovering lanthanum from zeolites containing lanthanum according to claim 1, characterized in that the pH value is lower than or equal to 1.

14. The method for recovering lanthanum from zeolites containing lanthanum according to claim 1, characterized in that the pH value is lower than or equal to 0.

15. The method for recovering lanthanum from zeolites containing lanthanum according to claim 1, characterized in that the aqueous acid is aqueous hydrochloric acid, aqueous sulfuric acid or aqueous nitric acid or a mixture of at least two of these acids.

16. The method for recovering lanthanum from zeolites containing lanthanum according to claim 15, characterized in that (B) dissolved lanthanum is separated by filtration from the insoluble solid residue.

17. The method for recovering lanthanum from zeolites containing lanthanum according to claim 16, characterized in that lanthanum dissolved in the filtrate is separated out by selective crystallization, selective precipitation or selective ion exchange of aluminum dissolved in the filtrate.

18. The method for recovering lanthanum from zeolites containing lanthanum according to claim 1, characterized in that (A) an aqueous acid is added to one or more zeolite compounds containing lanthanum, and during the acid digestion no heat is introduced from the outside.

19. The method for recovering lanthanum from zeolites containing lanthanum according to claim 6, characterized in that (A) an aqueous acid is added to one or more zeolite compounds containing lanthanum, and during the acid digestion no heat is introduced from the outside.

20. The method for recovering lanthanum from zeolites containing lanthanum according to claim 15, characterized in that (A) an aqueous acid is added to one or more zeolite compounds containing lanthanum, and during the acid digestion no heat is introduced from the outside.
